(19) United States
(12) Patent Application Publication
(10) Pub. No.: US 2012/0038210 A1
(43) Pub. Date: Feb. 16, 2012

(54) APPARATUS AND METHOD FOR ELECTRIC FLOATING STORAGE AND OFFLOADING

(75) Inventor: Stephen E. Kibbee, Katy, TX (US)

(73) Assignee: Seahorse Equipment Corp., Houston, TX (US)

(21) Appl. No.: 13/207,075

(22) Filed: Aug. 10, 2011

Related U.S. Application Data
(60) Provisional application No. 61/372,761, filed on Aug. 11, 2010.

(51) Int. Cl. H02J 3/32; H02J 7/35; H02J 7/00; B60L 11/18

(52) U.S. Cl. 307/9.1; 318/139; 320/101; 320/104

(57) ABSTRACT

An Electric Floating Storage and Offloading system comprises a floating vessel that may be moored at a location convenient for connection to the power grid and which supports an array of grid-scale batteries or other energy storage devices and has means for delivering stored electrical energy to the power grid or to an end user.

### CROSS-REFERENCE TO RELATED APPLICATIONS

This application claims the benefit of U.S. Provisional Application No. 61/372,761 filed on Aug. 11, 2010.

### STATEMENT REGARDING FEDERALLY SPONSORED RESEARCH OR DEVELOPMENT

Not Applicable

### BACKGROUND OF THE INVENTION

1. Field of the Invention

This invention relates to electrical power systems. More particularly, it relates to a system for supplying power to an electrical grid system from a floating vessel having storage means for electrical energy.

2. Description of the Related Art Including Information Disclosed Under 37 CFR 1.97 and 1.98

Some renewable electric power generation facilities produce electric power intermittently or in small quantities because renewable electricity can only be generated when the source energy is available in the environment. In contrast, electricity must be dispatched to the market when needed and in the amounts required. When renewable electric power generation capacity is relatively small, as it is now, conventional dispatchable sources of electricity, such as distributed gas fired power plants, are taken online/offline to accommodate the availability of renewable energy sources, but this is not an economic long-term solution due to start-up and shut-down cost of the stand-by generating units. Increasing amounts of energy storage will be required as more renewable electrics are connected to the grid. Energy storage capacity bridges the disconnect between the supply and demand for renewable electricity and adds value to renewable electric installations much as oil storage adds value to remote oil reserves.

Although the growth of renewable electrics highlights the need for energy storage on the grid, Energy Storage Systems (ESS) are already being added to the grid for other reasons. For example:

1. Load-shifting. ESS can be used to accumulate lower-cost, off-peak electric energy for later sale at higher rates. This presents financial opportunity and also has the real benefit of allowing deferral of investment in transmission, distribution, and generation facilities.

2. Ancillary grid services. ESS can provide critical ancillary services such as frequency regulation and voltage support that improve grid stability and reliability.

### BRIEF SUMMARY OF THE INVENTION

One illustrative embodiment of the invention comprises an Electric Floating Storage and Offloading system that: (1) may be moored at a location convenient for connection to the power grid; (2) supports an array of grid-scale batteries; and, (3) provides means for delivering stored electrical energy to the power grid or to an end user. In another embodiment, an accompanying crane barge lifts energy storage modules (e.g., grid-scale batteries) from a transport vessel (e.g., a barge) onto a shore foundation so that the facility transport barge can be released.

Another embodiment of the invention provides an energy transport system for supplying an electrical grid with power previously produced at another location (e.g., a renewable energy source). An exemplary embodiment comprises: an offshore source of electrical energy (e.g. wind, wave, tidal, ocean thermal, etc.); an energy storage device on a vessel [e.g., grid-scale batteries]; and, a shore-side (or river-side) electrical connection to a grid (to which the energy storage device may be transported by and connected). In another embodiment, stranded offshore gas reserves are used as fuel to generate electricity (at an offshore location) which may then stored in an ESS on a vessel for transport to an onshore grid connection.

Yet another embodiment of the invention permits electrical energy to be deployed in or near shipping lanes to replenish hybrid electric vessels (analogous to the “oilers” used to refuel naval vessels that use petroleum-based fuels). In this embodiment, one or more vessels carrying an energy storage device (or array of such devices) are stationed along a predetermined route of a hybrid electric vessel. The deployment positions may be at or near a renewable energy source thereby permitting the energy storage device to be charged. During the replenishment operation, the vessel having the ESS may be brought alongside the hybrid electric vessel and an electrical connection may be made which enables a transfer of electrical energy from the storage vessel to the hybrid electric vessel. As is now done with oilers, this may be accomplished while both vessels are underway.

FIG. 1 illustrates the general concept of a coastal electric floating, storage and offloading vessel (“e-FSO”).

Several types of battery technologies are evolving in the US/EU in response to large R&D programs in the automotive, utility, and defense industries. Grid-scale batteries have been put into service at locations in the US and abroad. These facilities have been constructed on location using truckable modules and components. A publication indicated that budget, schedule, and/or relocation was an issue on at least one of these projects.

### BRIEF DESCRIPTION OF THE SEVERAL VIEWS OF THE DRAWING(S)

FIG. 1A is a plan view of an e-FSO according to one embodiment of the invention shown in a coastal deployment.

FIG. 1B is a side view, partially in cross-section of an e-FSO in a coastal deployment connected via a floating umbilical system to the shore-side power grid.

FIG. 1C is a side view, partially in cross-section of an e-FSO in a coastal deployment connected via a buried umbilical to the shore-side power grid.

FIG. 2 is a plan view of a sequential deployment of an e-FSO according to the invention in an inland locale.

FIG. 3 is a plan view of two e-FSO's according to the invention deployed along an ocean shipping lane.

FIG. 4 is a perspective view of an e-FSO according to an embodiment of the invention which comprises a mechanical-type energy storage device.

FIG. 5 is a schematic representation of an e-FSO according to the invention connected to an on-shore electrical substation.

### DETAILED DESCRIPTION OF THE INVENTION

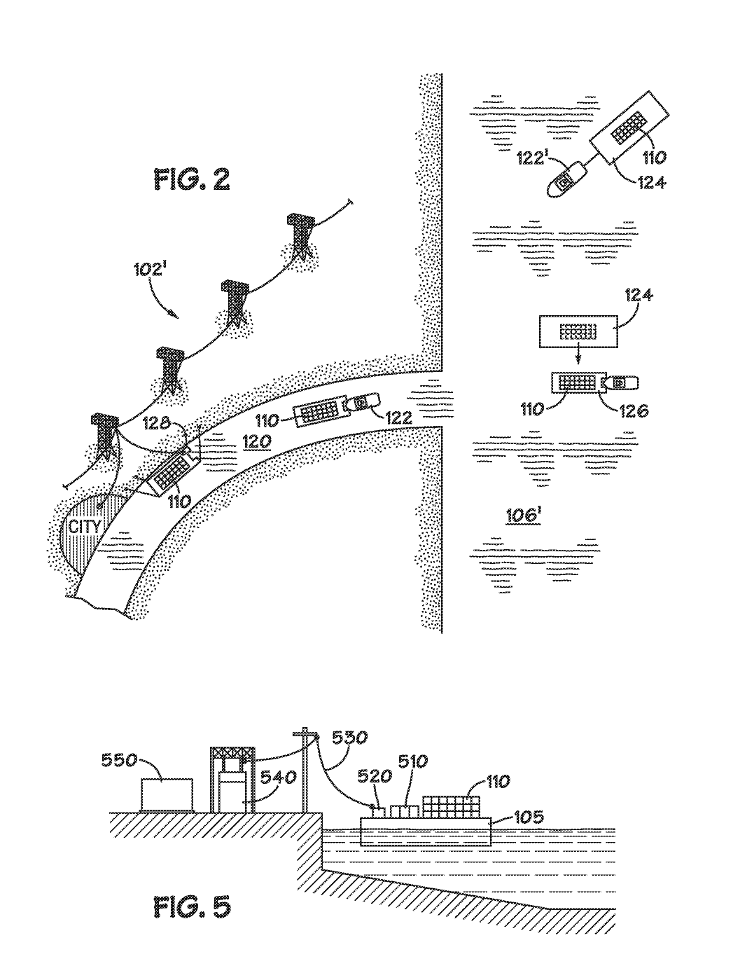

Many population centers, and therefore centers of electric power demand, are located in coastal areas or along navigable rivers. The type of vessel that supports the ESS may depend on the specifics of the application and the given marine environment. For example, if electricity were to be stored near a coastal load center like Monaco or New York City, the batteries may be integrated into a ship-shape, semisubmersible, or barge that offered reasonable motions in that marine environment. If energy storage were to be provided to a city on a river, e.g., St. Louis, Mo., the battery array may be integrated into a barge that may be transported on an oceangoing vessel, offloaded, and towed to final location on the river (FIG. 2).

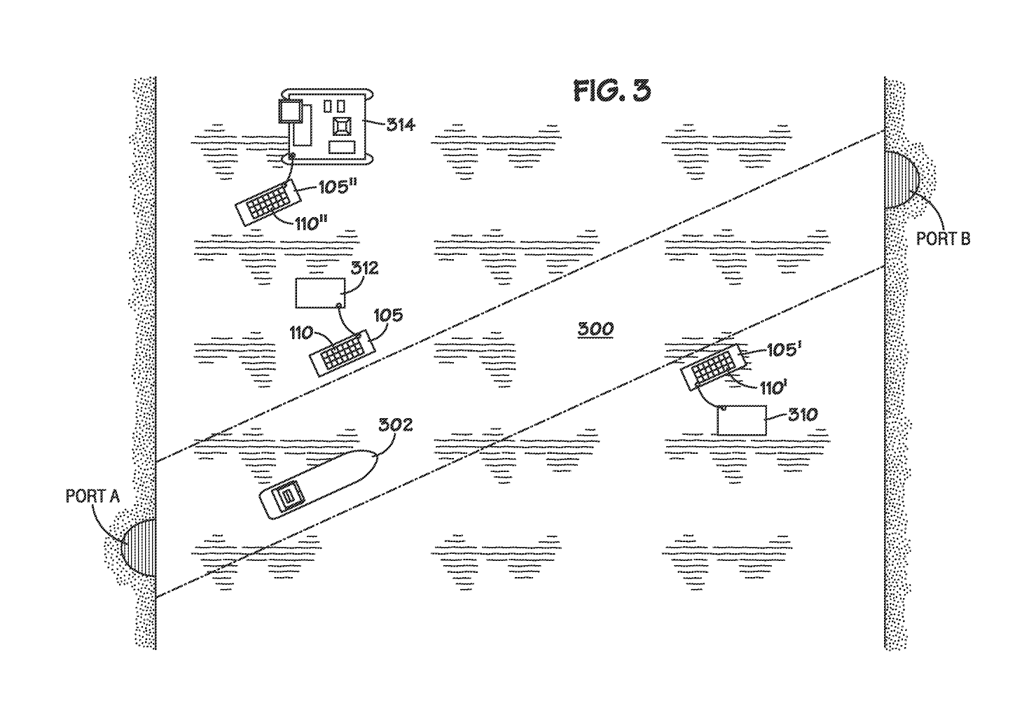

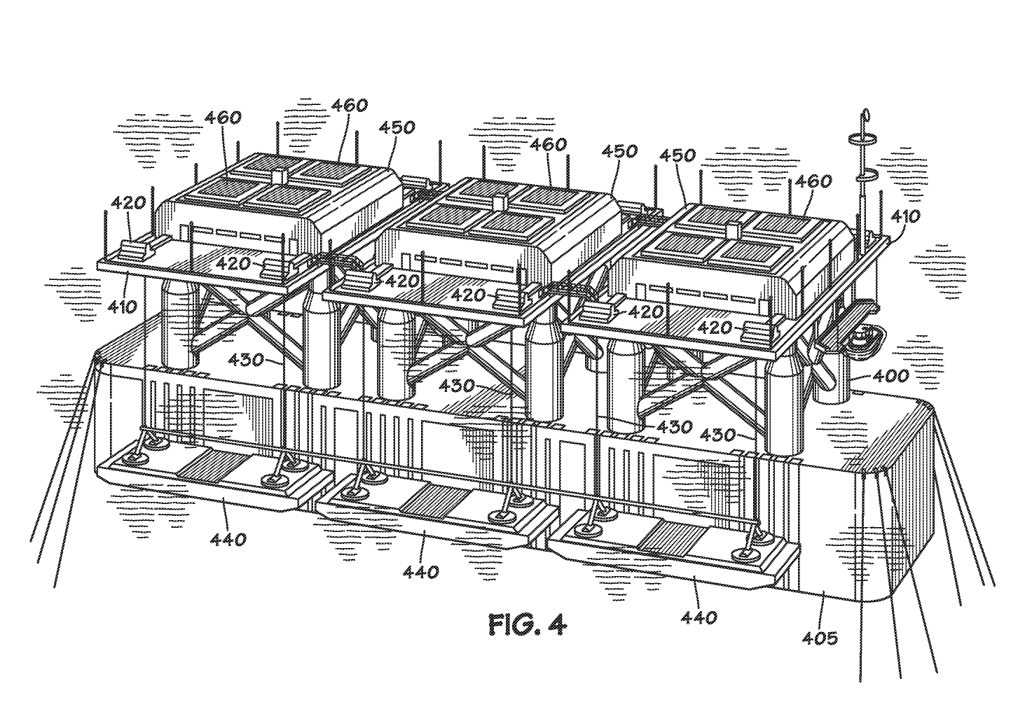

An e-FSO may also be located along shipping lanes and store energy for periodic discharge into hybrid electric ships (FIG. 4). The military may nucleate early infrastructure which may then subsequently become available and expanded for later commercial users.

Various types of energy storage devices may evolve to be supported on a marine vessel. A mechanical battery, which is a special type of e-FSO, may be possible when: (1) the marine climate is mild and (2) deepwater is relatively near the coast and grid-connection points. As shown in FIG. 5, potential energy may be stored underwater by using an electric motor to raise large, engineered, submerged weights. Electric power may later be delivered on demand, by lowering these same weights and converting the kinetic energy of the turning winch drums into electricity using a generator or alternator.

An e-FSO according to the present invention offers the following advantages:

### Minimal Real Estate.

Large ESS's may be located near major cities and load centers without requiring expensive coastal real estate.

### Safe Operation.

Advanced technology batteries may be located at safe distances from populated areas. This may be an advantage as certain grid-scale batteries operate at high temperatures and/or contain hazardous materials.

### Flexible Growth.

Additional units may be installed over time as energy storage requirements increase.

### Adaptable to Battery Technology Improvements.

The battery array on a given vessel may be changed out as battery technology improves over time.

### Mobility and Residual Value.

Energy storage units may be relocated as generation and load centers change over time. In some cases, an e-FSO according to the present invention may allow deferral of power generation facilities by enabling storage of off-peak energy for later discharge during daily peak demand.

### Reduced Construction Costs.

Large battery arrays may be cost-effectively integrated into the vessel at a manufacturer, shipyard, or fabrication yard and economically transported to the installation site. On-site construction work may be minimized.

### Transition to Renewable Energy Sources.

Energy storage units may be justified initially by enabling the purchase of energy at low off-peak rates for resale that same day at higher peak rates. As renewable electrics are added in a region, expandable energy storage infrastructure would already be in place to aggregate renewable energy and create more valuable dispatchable energy.

### Adjacent Technology.

As will be appreciated by those skilled in the art, much of the technology used in FPSO vessels used in petroleum production may be adaptable to the practice of the present invention.

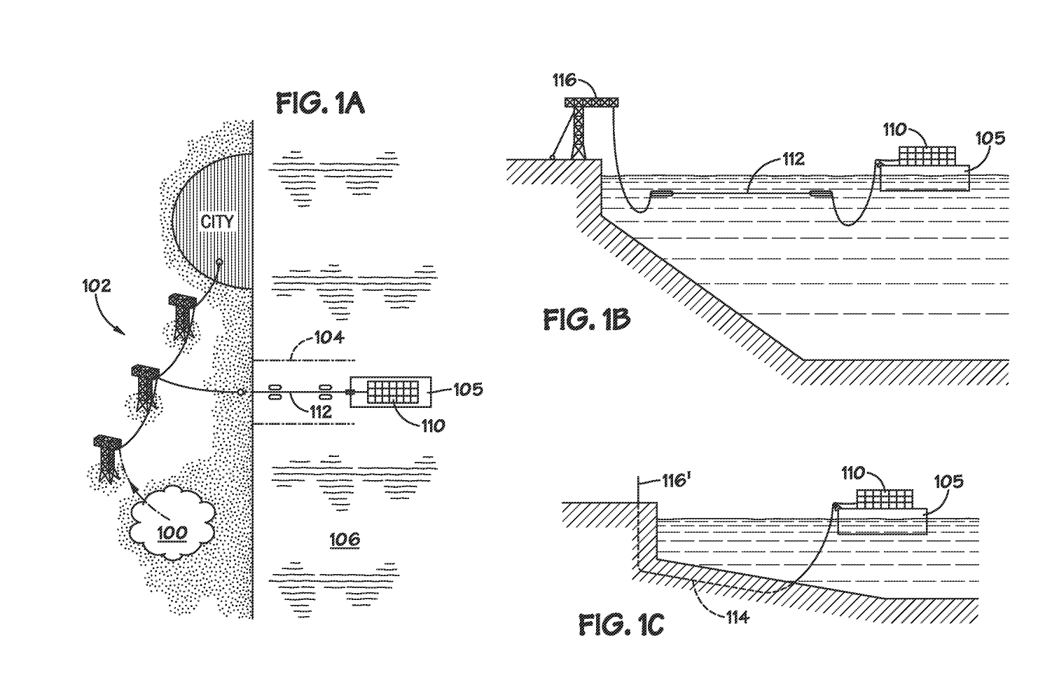

Referring now to FIG. 1A, an e-FSO 110 floating in body of water 106 and comprising grid-scale battery 110 is moored at shore connection facility 104 and connected to power grid 100 via floating umbilical 112 and transmission facility 102.

FIG. 1B shows e-FSO 105 comprising grid-scale battery 110 in electrical connection with on-shore transmission facility 116 via floating electrical umbilical 112.

FIG. 1C shows e-FSO 105 comprising grid-scale battery 110 in electrical connection with an on-shore electrical conduit 116′ via electrical umbilical 114 which is buried in the seabed for at least a portion of its length.

FIG. 2 illustrates how a charged, grid-scale battery 110 may be transported by an oceangoing vessel 124 (which may be towed by tug 122′) to near the mouth of navigable river 120. While still in body of water 106′, battery 110 may be transferred from vessel 124 to river barge 126 which may be pushed up-river by tug 122 to a mooring 128 for connection to electrical transmission facility 102′.

FIG. 3 shows how e-FSO's 105 according to an embodiment of the invention and comprising grid-scale batteries 110 may be deployed along a shipping lane 300 to replenish ship 302 which comprises a propulsion system that is at least in part powered by electrical energy. In certain embodiments, ship 302 may be replenished while underway with e-FSO 105 alongside it.

In the illustrated embodiment, battery 110 on e-FSO 105 is charged by renewable energy source 312 while battery 110′ on e-FSO 105′ is charged by renewable energy source 310 which may be the same or a different type of energy source as 312.

Also shown in FIG. 3 is floating power production source 314 which may be an offshore platform having generators powered by stranded natural gas produced offshore at or near platform 314. The electrical power generated on platform 314 may be used to charge grid-scale battery 110″ on e-FSO 105″. After charging, e-FSO 105″ may rendezvous with ship 302 for replenishment of its on-board electrical storage means.

FIG. 4 illustrates a mechanical battery 410 mounted on semi-submersible vessel 400 which comprises submerged hull 405. Winches 420 support submerged weights 440 on cables 430. Power generation modules 450 which may include solar power panels 460 supply the electrical power to winches 420 to raise weights 440. When power modules 450 are not producing power, weights 440 may be lowered, turning the drums of winches 420 which are mechanically connected to generators or alternators which produce electric power for immediate consumption.

FIG. 5 is a schematic view of an e-FSO according to an embodiment of the invention. e-FSO 105 comprises grid-scale battery 110, power conversion system 510 (which may comprise an inverter for converting the direct current supplied by battery 110 to alternating current) and transformer 520. Power may be supplied via electrical connection 530 to on-shore transformer 540 which, under the direction and control of power control system 550, may feed electrical power to an on-shore electrical power grid.

Although the invention has been described in detail with reference to certain preferred embodiments, variations and modifications exist within the scope and spirit of the invention as described and defined in the following claims.

What is claimed is:

1. A floating vessel comprising:
means for storing electrical energy; and,
means for connecting the electrical energy storage means to an on-shore electrical grid.

2. A vessel as recited in claim 1 wherein the means for storing electrical energy comprises a grid-scale battery.

3. A vessel as recited in claim 2 wherein the grid-scale battery is a chemical battery.

4. A vessel as recited in claim 3 wherein the battery is a sodium sulfur battery.

5. A vessel as recited in claim 2 wherein the battery is a mechanical battery.

6. A vessel as recited in claim 5 wherein the mechanical battery comprises subsea weights which are raised and lowered from the vessel by motor-generator units.

7. A vessel as recited in claim 1 wherein the means for connecting the electrical energy storage means to an on-shore electrical grid comprises a transformer.

8. A vessel as recited in claim 1 wherein the means for connecting the electrical energy storage means to an on-shore electrical grid comprises an inverter.

9. A vessel as recited in claim 1 wherein the means for connecting the electrical energy storage means to an on-shore electrical grid comprises a floating umbilical.

10. A vessel as recited in claim 1 wherein the means for connecting the electrical energy storage means to an on-shore electrical grid comprises an umbilical at least of portion of which is buried in the seabed.

11. A vessel as recited in claim 1 wherein the vessel is a barge.

12. A vessel as recited in claim 1 wherein the vessel is a self-propelled ship.

13. A method for supply power to an electrical grip comprising:
generating electric power at a first location;
storing the electric power generated at the first location in the energy storage means of a vessel according to claim 1;
moving the vessel to a second location remote from the first location;
connecting the vessel to an on-shore electrical grid; and
supplying power from the energy storage means of the vessel to the on-shore electrical grid.

14. A method as recited in claim 13 wherein generating electric power at a first location comprises generating power from a renewable energy resource.

15. A method as recited in claim 14 wherein the renewable energy resource is wind energy.

16. A method as recited in claim 14 wherein the renewable energy resource is wave energy.

17. A method as recited in claim 14 wherein the renewable energy resource is tidal energy.

18. A method as recited in claim 14 wherein the renewable energy resource is ocean thermal energy.

19. A method as recited in claim 13 wherein generating electric power at a first location comprises generating power from offshore stranded gas.

20. A method for replenishing oceangoing vessels having a propulsion system that operates at least in part on electrical energy comprising:
charging a battery on a first vessel at a first location using a renewable energy resource;
moving the first vessel to a second location;
moving a second vessel having a propulsion system that operates at least in part on electrical energy to the second location;
transferring electrical energy from the battery on the first vessel to the second vessel.

21. A method as recited in claim 20 wherein the second location is proximate a shipping lane.

22. A method as recited in claim 20 wherein the transferring of electrical energy is accomplished while the first vessel and the second vessel are underway.

23. A method for replenishing oceangoing vessels having a propulsion system that operates at least in part on electrical energy comprising:
charging a battery on a first vessel at a first location using a renewable energy resource;
moving the first vessel to a second location;
moving a second vessel having a propulsion system that operates at least in part on electrical energy to the second location;
transferring the battery on the first vessel to the second vessel.

24. A method as recited in claim 23 further comprising transferring an at least partially discharged battery from the second vessel to the first vessel.

25. A method for replenishing oceangoing vessels having a propulsion system that operates at least in part on electrical energy comprising:
charging a battery on a first vessel at an offshore location using a renewable energy resource;
moving a second vessel having a propulsion system that operates at least in part on electrical energy to the offshore location;
transferring electrical energy from the battery on the first vessel to the second vessel.

26. A method for replenishing oceangoing vessels having a propulsion system that operates at least in part on electrical energy comprising:
charging a battery on a first vessel at an offshore location using a renewable energy resource;
moving a second vessel having a propulsion system that operates at least in part on electrical energy to the offshore location;
transferring the battery on the first vessel to the second vessel.

27. A method as recited in claim 26 further comprising transferring an at least partially discharged battery from the second vessel to the first vessel.

28. A method for supplying electrical power to a power grid comprising:
generating power at a first location using a renewable energy resource;
charging a grid-scale battery using the generated power;
transporting the charged, grid-scale battery to a second location having a connection to a power grid;
connecting the charged, grid-scale battery to the power grid.

29. A method as recited in claim 28 further comprising transporting an at least partially discharged battery from the second location to the first location.

30. A method as recited in claim 28 wherein the first location is an offshore location.
